(19) United States
(12) Patent Application Publication
(10) Pub. No.: US 2011/0252676 A1
(43) Pub. Date: Oct. 20, 2011

(54) INTERCHANGEABLE DISPLAY SYSTEM

(76) Inventor: Joseph Kenneth Stringer, Lake Oswego, OR (US)

(21) Appl. No.: 12/762,524

(22) Filed: Apr. 19, 2010

(51) Int. Cl. G09F 21/04; B60R 13/10; B60D 1/60

(52) U.S. Cl. 40/210; 40/591

(57) ABSTRACT

An interchangeable display system for attachment to a motor vehicle is presented. The display system can be used in a hitch cover, a license plate frame, or other systems that are attached to vehicles for the purpose of displaying desired indicia. In one aspect, the display system has a body configured for attachment to a portion of a motor vehicle and a display member for displaying the indicia. The body defines at least one display recess. The display recess is sized to accept the display member.

### FIELD OF THE INVENTION

Presented herein is an interchangeable display system. More specifically, a display system primarily used to interchangeably display indicia on a portion of a motor vehicle.

### BACKGROUND OF THE INVENTION

In the automotive industry, consumers are constantly demanding new and innovative aftermarket products to enhance the aesthetic appearance of their vehicle. Over the past few years, the industry has witnessed vehicles being lowered to create what are known as “low riders.” There have been vehicles with neon lights installed on the undercarriage, as well as hub caps and rims that remain spinning after the vehicle comes to a resting position.

In the advertising industry, motor vehicles have been a target for inexpensive advertising for years. People use decals on their vehicles to promote products, sports teams, and businesses. Additionally, other forms of advertising are common, such as magnetic signs, banners or flags that attach to a vehicles' window, or simply a bumper sticker.

Hitch covers and license plate holders often have indicia displayed that show off the car owners' preference in sports teams, hobbies, and the like. In certain instances, such as advertising, it may be beneficial to have the ability to change graphic designs on the display assembly without substantial effort on the part of the end user.

### SUMMARY

Presented herein is an interchangeable display system for attachment to a motor vehicle. In one aspect, the display system can be used in a hitch cover, a license plate frame, or other systems that are attached to vehicles for the purpose of displaying desired indicia. In one aspect, the display system comprises a body configured for attachment to a portion of a motor vehicle and a display member for displaying the indicia. The body defines at least one display recess. The display recess is sized to accept the display member.

The display system can be a hitch cover. In this aspect, the display system further comprises a hitch insert extending therefrom a back face of the body. The hitch insert is configured for a mating relationship with the hitch receptacle of the motor vehicle. In another aspect, the system comprises a license plate frame. In this aspect, the body comprises a frame having a perimeter and defining a license plate opening. The perimeter is configured to retain a license plate and to overlay a surface of the license plate. The license plate opening is configured to permit characters on the license plate surface to be viewable to persons proximate the license plate surface when the perimeter is overlaid on the license plate surface. In this aspect, the display recess is defined on a portion of the perimeter.

Other aspects and embodiments of the display system are described herein. This description is meant to fully describe the display system, but not limit its design, function, or application.

### BRIEF DESCRIPTION OF THE DRAWINGS

These and other features of the preferred embodiments of the present invention will become more apparent in the detailed description in which reference is made to the appended drawings wherein:

FIG. 1 is front elevational view of an exemplary display system, illustrating a body defining a plurality of display recesses configured for receipt of display members;

FIG. 2 is a perspective view of the display system of FIG. 1, showing one display member positioned within a display recess and one display member removed therefrom a display recess;

FIG. 3 is a front elevational view of an exemplary display system, illustrating an aperture therethrough the front face of the body;

FIG. 4 is a side elevational view of the display system of FIG. 3;

FIG. 5 is a perspective view of the display system of FIG. 3, showing a display member positioned therein the display recess; and

FIG. 6 is a perspective view of the display system of FIG. 3, showing the display member removed therefrom the display recess.

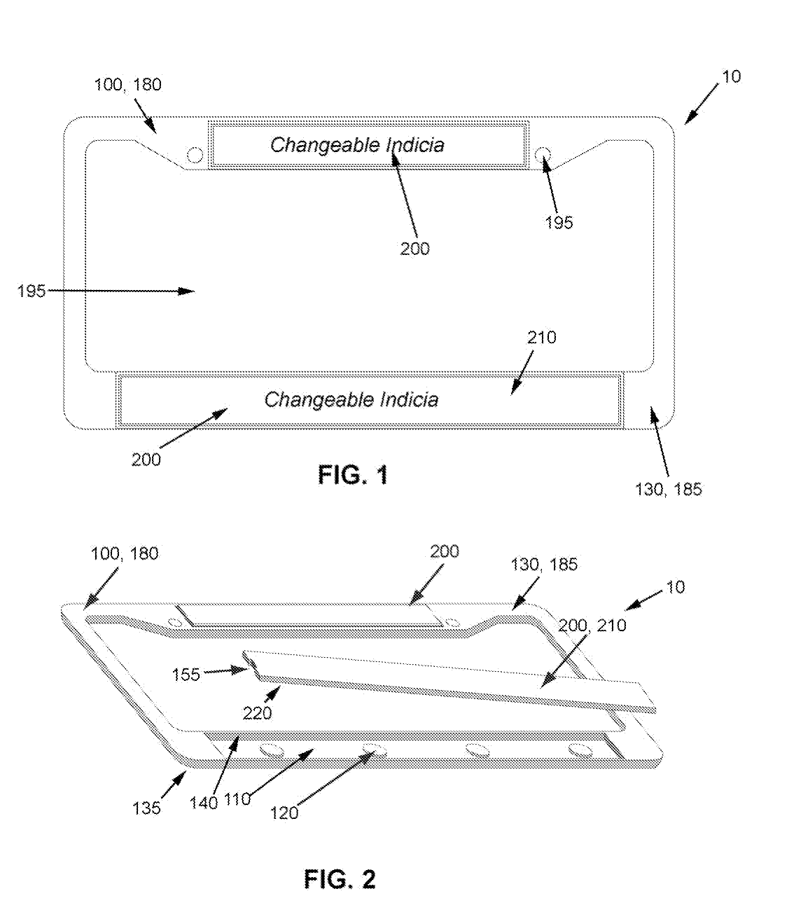

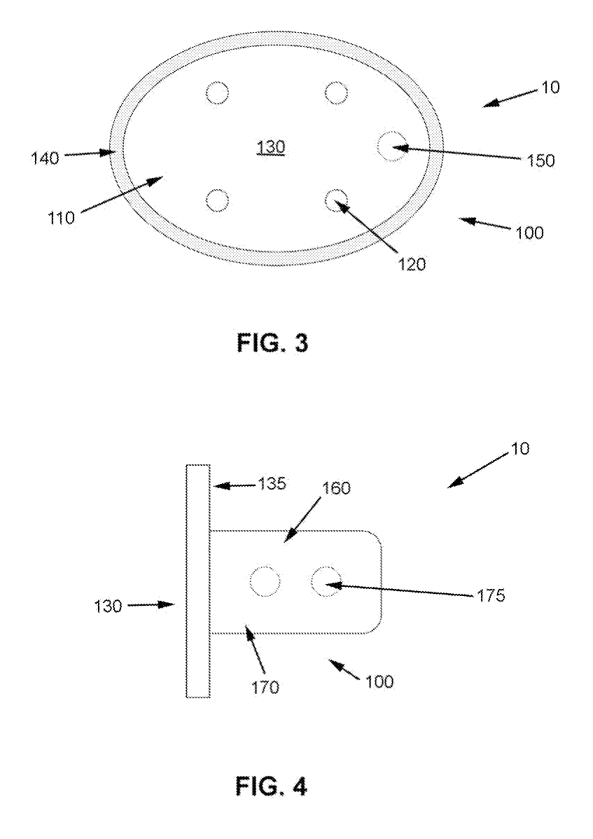

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a recess” can include two or more such recesses unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Presented herein is an interchangeable display system 10 for attachment to a motor vehicle. In one aspect, the display system 10 can be used in a hitch cover, a license plate frame, or other systems that are attached to vehicles for the purpose of displaying desired indicia. The indicia can be, for example and not meant to be limiting, licensed trademarks of professional or college sports teams, advertising, and the like.

In one aspect, the display system comprises a body 100 configured for attachment to a portion of a motor vehicle and a display member 200 for displaying the indicia. The body 100 defines at least one display recess 110. The display recess 110 is sized to accept the display member 200.

In one aspect, the a display member has a first face 210 that faces toward the body and an opposing second face 220 configured for displaying indicia. The indicia may be engraved, etched, enameled, die-cast, formed, embossed, or otherwise printed on the second face 220. In another aspect, the display member is releasably positioned within the display recess. The body, in one aspect, is configured to selectively retain the display member within the display recess by releasably engaging at least a portion of the second face of the display member 200.

In an exemplary aspect, the body 100 is equipped with one or more magnet(s) 120 positioned within the display recess 110 for retention of the display member. In this aspect, the display member comprises a ferrous metal to engage the magnet(s) 120. It is contemplated that the body is equipped with alternate means of attachment. For example and not meant to be limiting, the body may comprise hook and loop material, a releasable adhesive, double sided tape, and the like.

In one aspect, the body has a front face 130 and a raised peripheral lip 140 defining the display recess 110. The display member can be positioned within the display recess such that the first face 210 lies in a plane that is substantially within the display recess. As such, the display member 200 would be very difficult to remove from the display recess, as there would not be a surface with which a user could grab. In this aspect, the front face 130 of the body defines an aperture 150 therethrough, positioned to allow a tool to be inserted therein the aperture 150 to push the display member out of engagement with the body 100 and out of the display recess 110. As one skilled in the art can appreciate, the tool can be an awl, a screwdriver, or some other tool narrow enough to fit within the aperture.

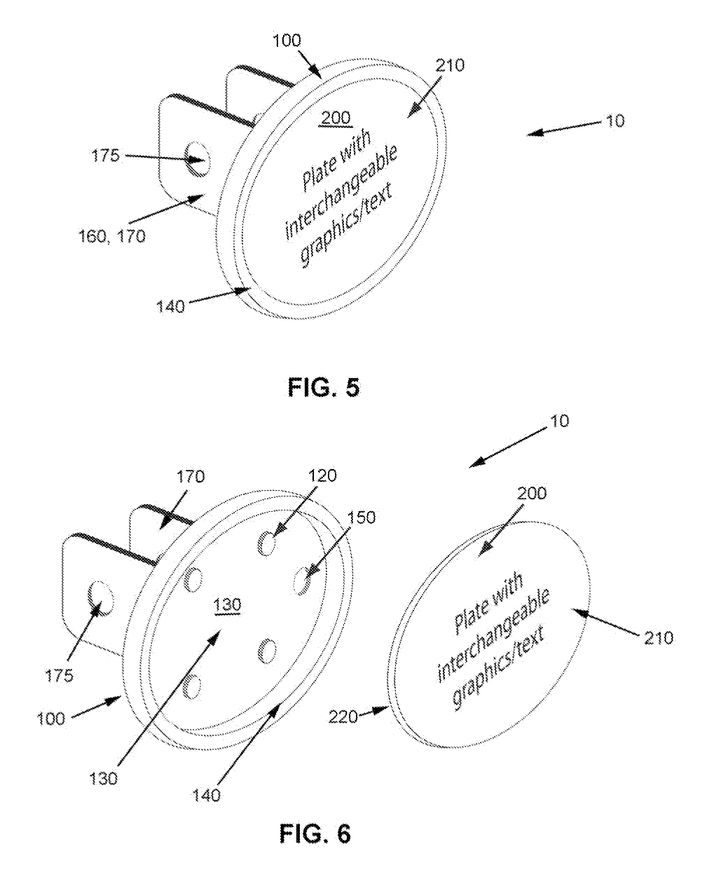

As mentioned herein above, the display system 10 can be a hitch cover. In this aspect, the display system further comprises a hitch insert 160 extending therefrom a back face 135 of the body. The hitch insert 160 is configured for a mating relationship with the hitch receptacle of the motor vehicle. In one aspect, the hitch insert can be a pair of hitch insert legs 170, as shown in FIG. 5. The hitch insert can also be a single leg. Alternately, as one skilled in the art can appreciate, the hitch insert 160 can be square shaped, configured for insertion into the hitch receptacle. The hitch insert can be sized for a friction fit, or it can define one or more hitch insert apertures 175 that, when inserted into the hitch receptacle, are substantially coaxial with the locking apertures of the vehicle's hitch system.

In another aspect, the system comprises a license plate frame. In this aspect, the body 100 comprises a frame 180 having a perimeter 185 and defining a license plate opening 190. The perimeter 185 is configured to retain a license plate and to overlay a surface of the license plate. The license plate opening 190 is configured to permit characters on the license plate surface to be viewable to persons proximate the license plate surface when the perimeter is overlaid on the license plate surface. In this aspect, the display recess is defined on a portion of the perimeter. As shown in FIG. 2, the body can also define a plurality of display recesses for receipt of a plurality of display members. In yet another aspect, the frame 180 defines a pair of attachment orifices 195 that are substantially coaxial with respective orifices in the license plate, configured to attach the license plate, along with the frame, to the vehicle.

As one skilled in the art can appreciate, the display member(s) of the license plate frame embodiment can be difficult to remove if they are positioned in the display recess(es) snugly. The aperture used in the hitch cover embodiment may or may not work, as the license plate frame is generally positioned closely adjacent the vehicle. As such, in one aspect, the display member 200 defines a peripheral notch 155 configured to permit a tool to pry the display member therefrom the display recess.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. An interchangeable display system, comprising:
a body configured for attachment to a portion of a motor vehicle, the body defining a display recess;
a display member, having a first face that faces toward the body and an opposing second face configured for displaying indicia, wherein at least a portion of the display member is releasably positioned within the display recess; and
wherein the body comprises means for releasably engaging at least a portion of the second face.

2. The display system of claim 1, further comprising a hitch insert extending therefrom a back face of the body, wherein the hitch insert is configured for a mating relationship with a hitch receptacle of the motor vehicle.

3. The display system of claim 2, wherein the hitch insert comprises a pair of hitch insert legs.

4. The display system of claim 3, wherein the hitch insert comprises a square shape configured for insertion into the hitch receptacle.

5. The display system of claim 1, wherein the body comprises a frame having a perimeter and defining a license plate opening, the perimeter being configured to retain a license plate and to overlay a surface of the license plate, the license plate opening being configured to permit characters on the license plate surface to be viewable to persons proximate the license plate when the perimeter is overlaid on the surface of the license plate, and wherein the display recess is defined on a portion of the perimeter.

6. The display system of claim 5, wherein the frame defines a pair of attachment orifices that are substantially coaxial with respective orifices in the license plate, configured to attach the license plate, along with the frame, to the vehicle.

7. The display system of any of claim 1, 2, or 5 wherein the body comprises at least one magnet positioned within the display recess and wherein at least a portion of the display member comprises a ferrous metal.

8. The display system of claim 7, wherein the body comprises a plurality of spaced magnets positioned within the display recess.

9. The display system of claim 1, wherein the body has a front face and a raised peripheral lip defining the display recess.

10. The display system of claim 1 or 2, wherein the display member is positioned within the display recess such that the first face lies in a plane that is substantially within the display recess.

11. The display system of claim 10, wherein the front face of the body defines an aperture therethrough positioned to allow a tool to be inserted therein the aperture to push the display member out of engagement with the body and out of the display recess.

12. The display system of claim 1 or 5, wherein the display member defines a peripheral notch configured to permit a tool to pry the display member therefrom the display recess.

13. The display system of claim 1 or 5, wherein the body defines a plurality of display recesses, and wherein the display member comprises a plurality of display members.

14. An interchangeable display system, comprising:
a body configured for attachment to a portion of a motor vehicle, the body defining a display recess;
a hitch insert extending therefrom a back face of the body, wherein the hitch insert is configured for a mating relationship with a hitch receptacle of the motor vehicle;
a display member, having a first face that faces toward the body and an opposing second face configured for displaying indicia, wherein at least a portion of the display member is releasably positioned within the display recess; and
wherein the body comprises means for releasably engaging at least a portion of the second face.

15. An interchangeable display system, comprising:
a frame having a perimeter and defining a license plate opening, the perimeter being configured to retain a license plate and to overlay a surface of the license plate, the license plate opening being configured to permit characters on the license plate surface to be viewable to persons proximate the license plate when the perimeter is overlaid on the surface of the license plate, wherein a portion of the perimeter defines a display recess;
a display member, having a first face that faces toward the body and an opposing second face configured for displaying indicia, wherein at least a portion of the display member is releasably positioned within the display recess; and
wherein the body comprises means for releasably engaging at least a portion of the second face.

16. The display system of claim 15, wherein the frame defines a plurality of display recesses, and wherein the display member comprises a plurality of display members.
